(19) United States
(12) Patent Application Publication
(10) Pub. No.: US 2016/0292727 A1
(43) Pub. Date: Oct. 6, 2016

(54) SYSTEM AND METHOD FOR IMPROVED USE OF SOCIAL MEDIA PLATFORMS TO MARKET OVER THE INTERNET

(71) Applicant: Nissan North America, Inc., Franklin, TN (US)

(72) Inventors: VIKRAM KRISHNAMURTHY, SMYRNA, GA (US); TOSHIRO MURAMATSU, SUNNYVALE, CA (US)

(21) Appl. No.: 14/672,323

(22) Filed: Mar. 30, 2015

(51) Int. Cl. G06Q 30/02

(52) U.S. Cl. CPC G06Q 30/0255

(57) ABSTRACT

A computer-aided method for marketing to subjects in a social media platform over the internet comprises supplementing social media data derived from a social media platform and representing candidate subjects for marketing with demographic data derived from outside social media platforms and representing attributes of a population by assigning, in data, the candidate subjects with demographic tags that indicate an attribute of their population. A cluster of target subjects for marketing is selected, from the data, from among the candidate subjects based on the demographic tags, and a marketing message is sent, over the internet using a social media platform, to at least one of the target subjects in the cluster.

### TECHNICAL FIELD

This disclosure relates to systems and methods for marketing over the internet, and in particular, to improvements in the use of social media platforms to market over the internet.

### BACKGROUND

A common goal for any brand in conducting a marketing campaign is to guide subjects towards a purchase of one or more of the brand's products or services. With the proliferation of social media platforms and the subjects in those social media platforms, brands are increasingly using social media platforms to market over the internet. Brands may however desire continued improvements in how social media platforms are used to market over the internet in order to more effectively guide subjects towards a purchase.

### SUMMARY

Disclosed herein are embodiments of methods and computing devices for marketing to subjects in a social media platform over the internet. In one aspect, a computer-aided method for marketing to subjects in a social media platform over the internet comprises supplementing social media data derived from a social media platform and representing candidate subjects for marketing with demographic data derived from outside social media platforms and representing attributes of a population by assigning, in data, the candidate subjects with demographic tags that indicate an attribute of their population. A cluster of target subjects for marketing is selected, from the data, from among the candidate subjects based on the demographic tags, and a marketing message is sent, over the internet using a social media platform, to at least one of the target subjects in the cluster.

In another aspect, a computing device for marketing to subjects in a social media platform over the internet comprises a memory including a non-transitory computer readable medium and a processor configured to execute instructions stored on the non-transitory computer readable medium to supplement social media data derived from a social media platform and representing candidate subjects for marketing with demographic data derived from outside social media platforms and representing attributes of a population by assigning, in data, the candidate subjects with demographic tags that indicate an attribute of their population. The processor is further configured to execute instructions stored on the non-transitory computer readable medium to select, from the data, a cluster of target subjects for marketing from among the candidate subjects based on the demographic tags, and send, over the internet using a social media platform, a marketing message to at least one of the target subjects in the cluster.

In yet another aspect, a computer-aided method for marketing to subjects in a social media platform over the internet comprises defining a geographic region, collecting social media data derived from a social media platform and representing candidate subjects for marketing located in the geographic region, and collecting demographic data derived from outside social media platforms and representing attributes of a population in the geographic region. Based on the demographic data, for each of the candidate subjects, a plurality of attributes of their population is identified, including an attribute relating to the population's mobility preference, and, in data, each of the candidate subjects is assigned with demographic tags that indicate the identified attributes of their population. A cluster of target subjects for marketing is selected, from the data, from among the candidate subjects based on similarities in the demographic tags for the target subjects, and an automotive brand's marketing message is sent, over the internet using a social media platform, to at least one of the target subjects in the cluster.

These and other aspects will be described in additional detail below.

### BRIEF DESCRIPTION OF THE DRAWINGS

The various features, advantages and other uses of the present systems and methods will become more apparent by referring to the following detailed description and drawings in which:

FIG. 1 is a flowchart showing operations for identifying target subjects for marketing among subjects in a social media platform, including operations for identifying candidate subjects in a given geographic region, tagging the candidate subjects, and creating clusters of target subjects based on the tagging;

FIG. 2 is a schematic diagram representing a system for identifying and marketing to the target subjects;

FIG. 3 is a diagram representing identifying the candidate subjects;

FIG. 4 is a flowchart showing operations for identifying the candidate subjects;

FIG. 5 is a flowchart showing operations for tagging the candidate subjects, including operations for tagging the candidate subjects with purchase stage information, and tagging the candidate subjects with demographic information from outside the social media platform;

FIG. 6 is a diagram of a purchase funnel representing example purchase stages for the candidate subjects;

FIG. 7 is a diagram representing tagging the candidate subjects with demographic information from outside the social media platform; and

FIG. 8 is a flowchart showing operations for marketing to the target subjects over the internet using the social media platform, including operations for evaluating the effectiveness of the marketing based on changes in target subjects' purchase stages.

### DETAILED DESCRIPTION

The examples described below implement the internet to market to subjects in a social media platform. In these examples, social media data representing the subjects is supplemented with demographic data collected from outside the social media platform. The demographic data is used to group like subjects in clusters. Marketing messages relating to a brand are tailored to the clusters and sent to at least some of the subjects in the clusters over the internet using the social media platform. The likeness of the subjects in the clusters, and the tailoring of the marketing messages to the clusters, can, for example, support the spread and positive reception of the marketing message among the subjects in the clusters.

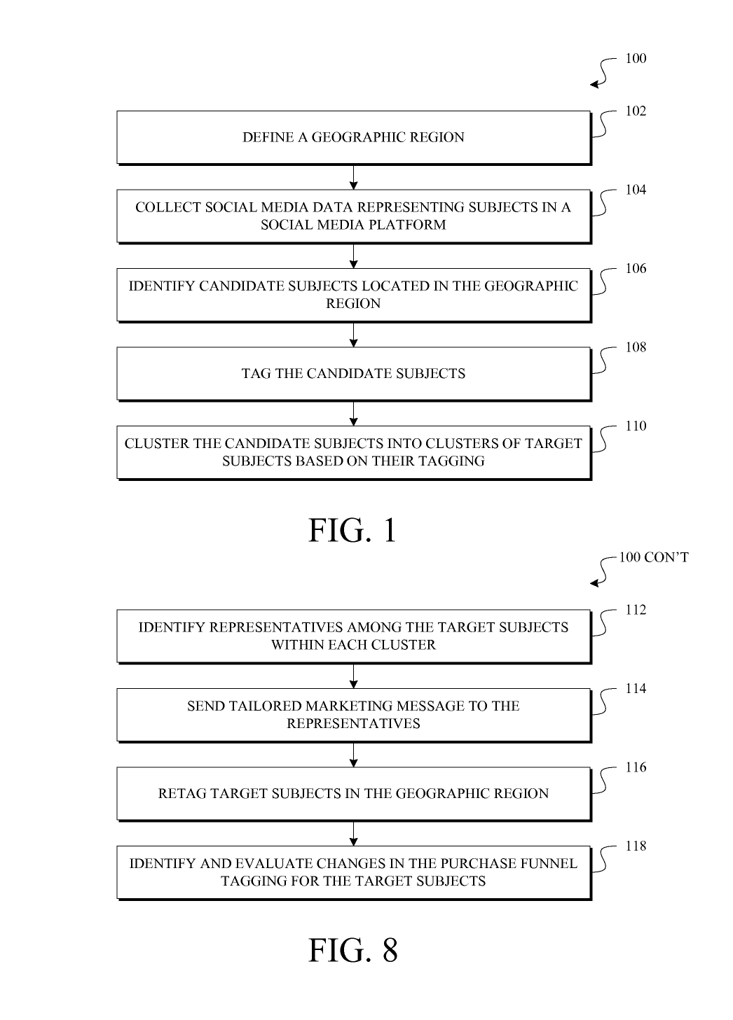

FIGS. 1 and 8 show the operations of a process 100 for marketing to subjects in a social media platform over the internet. As explained below, the operations of the process 100 shown in FIG. 1 concern the identification of target subjects for marketing among subjects in a social media platform, while the operations of the process 100 shown in FIG. 8 concern marketing to the target subjects over the internet using the social media platform.

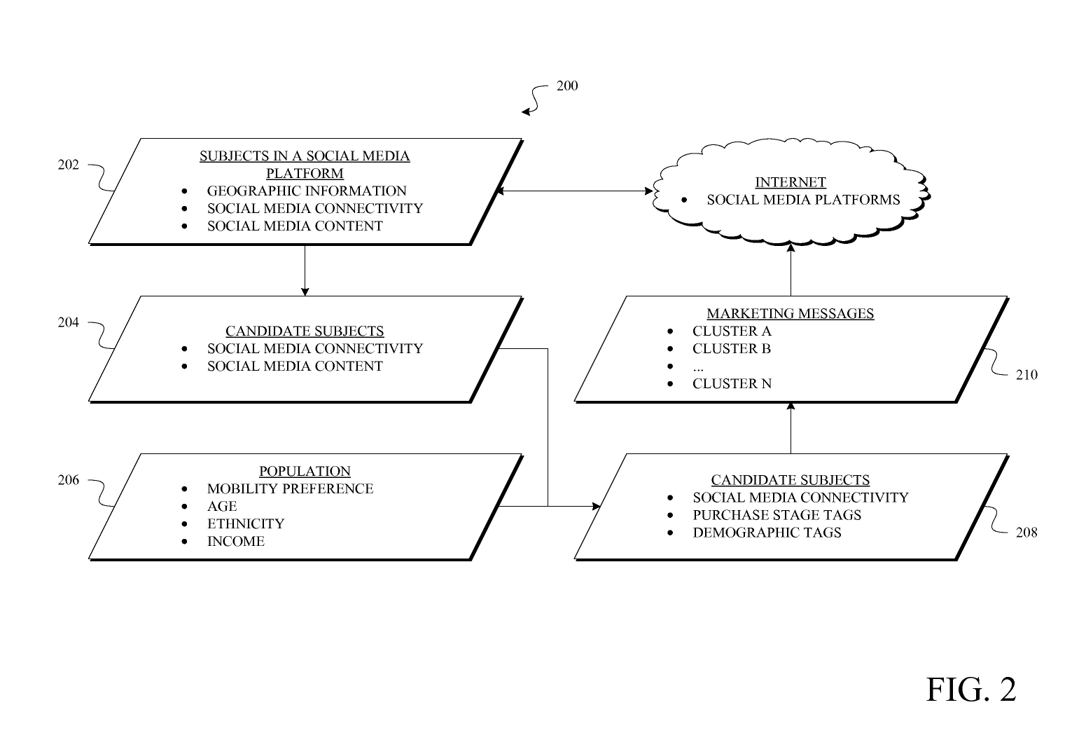

FIG. 2 represents a system 200 for carrying out the methods of the process 100. It will be understood that the system 200 can include computing devices. Implementations of computing devices used to carry out the methods of the process 100 (and the algorithms, methods, instructions, etc., stored thereon and/or executed thereby as described herein) may be realized in systems including hardware, software, or any combination thereof. The hardware can include, for example, computers, IP cores, ASICs, PLAs, optical processors, PLCs, microcode, microcontrollers, servers, microprocessors, digital signal processors or any other suitable circuit. In the claims, the term “processor” should be understood as encompassing any of the foregoing hardware or other like components to be developed, either singly or in combination.

In one example, a computing device may be implemented using a general purpose computer or general purpose processor with a computer program that, when executed, carries out any of the respective methods, algorithms and/or instructions described herein. In addition or alternatively, for example, a special purpose computer/processor can be utilized which can contain other hardware for carrying out any of the methods, algorithms, or instructions described herein. Further, some or all of the teachings herein may take the form of a computer program product accessible from, for example, a tangible (i.e., non-transitory) computer-usable or computer-readable medium. A computer-usable or computer-readable medium is any device that can, for example, tangibly contain, store, communicate, or transport the program for use by or in connection with any processor. The medium may be an electronic, magnetic, optical, electromagnetic or semiconductor device, for example.

As described herein, the methods and systems include a series of steps. Unless otherwise indicated, the steps described may be processed in different orders, including in parallel. Moreover, steps other than those described may be included in certain implementations, or described steps may be omitted or combined, and not depart from the teachings herein. The use of the term “collecting” is not meant to be limiting and encompasses both actively collecting and receiving data.

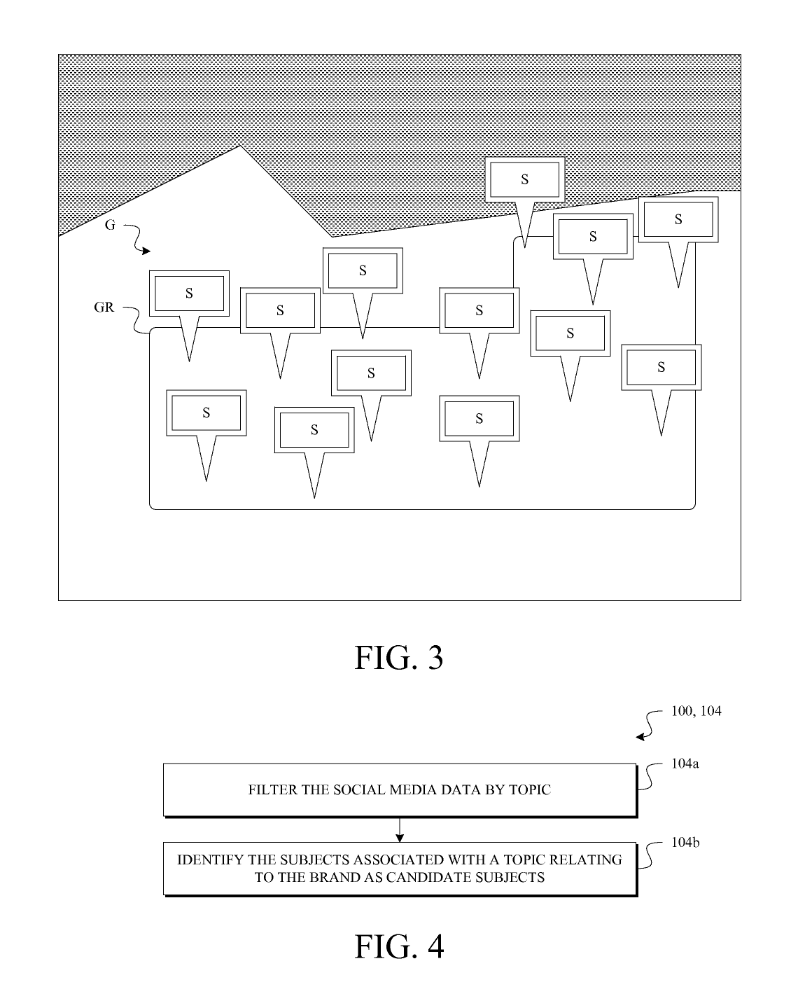

According to the illustrated example shown in FIG. 1, and with additional reference to FIG. 3, the process 100 commences in step 102, where a geographic region GR is defined among a geography G. The geographic region GR can be, or include, any geographic area or combination of geographic areas. The geographic region GR can be defined arbitrarily or according to criteria. Ultimately, subjects S in a social media platform and located in the geographic region GR are marketed to over the internet using the social media platform. In some examples, the geographic region GR can be, or include, for instance, a specific geographic area or combination of geographic areas that a brand desires to market to, either in the first instance, with improved effectiveness over existing marketing or as a continuation of existing marketing, for example.

As shown with additional reference to FIG. 2, the system 200 is configured to connect to and communicate over the internet, which may include, or provide access to, one or more social media platforms.

In step 104 of the process 100, social media data is collected and stored as social media data 202. The social media data 202 is derived from a social media platform and represents, as data, the subjects S in a social media platform. For ease of description only, herein, reference is made generally to subjects S represented in “a” social media platform. It will be understood that these references are not exclusive to the social media data 202 representing subjects S in multiple social media platforms. Moreover, for particular subjects S represented in more than one social media platforms, these references are inclusive of the social media data 202 being collected from one, some or all of the social media platforms.

In addition to generally representing subjects S in a social media platform, the social media data 202 may represent, for those subjects S, as data, information about the subjects S, such as geographic information, social media connectivity and social media content, for instance. The geographic information for a subject S can be represented in the social media data 202, for example, by so-called geotags or other information that indicates the geographic location of the subject S. The social media connectivity for a subject S can be represented in the social media data 202, for example, by information indicating both direct and indirect connections between the subject S and other subjects S over a social media platform. The social media content for a subject S can be represented in the social media data 202, for example, by information indicating the content that the subject S makes available to the internet over a social media platform, including without limitation content that the subject S publically or privately shares with other subjects S.

In step 106 of the process 100, candidate subjects S for marketing are identified from among the subjects S represented in the social media data 202. According to the example, the identified candidate subjects S may be located in the geographic region GR. These candidate subjects S may, for example, be identified using the geographic information for the subjects S represented in the social media data 202. As described above, this geographic information indicates the geographic location of the subjects S, and therefore may be used to locate the subjects S in the geographic region GR from among the subjects S represented in the social media data 202.

The candidate subjects S for marketing may be, for example, all of the subjects S represented in the social media data 202 and located in the geographic region GR. Alternatively, the candidate subjects S can be a subset of these subjects S. For instance, as shown with additional reference to FIG. 4, the social media data 202 can be filtered to identify or support the identification of candidate subjects S among the subjects S represented in the social media data 202 and located in the geographic region GR.

In step 106a, for instance, the social media data 202 may be filtered by one or more topics. The topics by which the social media data 202 is filtered can be, or include, topics that relate to the brand that will ultimately market to the subjects S located in the geographic region GR according to the process 100. Taking an automotive brand as an example, the topics may relate, for instance, to automobiles generally, to the automotive brand itself generally, to one of the automotive brand's product lines, or to one or more of the automotive brand's specific products or services.

According to step 106a, the social media data 202 is filtered by topics including one or more topics relating to the brand. The filtering is generally configured to identify instances of the subjects S located in the geographic region GR demonstrating some degree of awareness, over a social media platform, of the topics. This demonstrated awareness may indicate, for example, that the subjects S are potential purchasers from the brand. The demonstrated awareness may be reflected in any of the available information about the subjects S represented the social media data 202, such as, for example, their social media connectivity and/or their social media content. The demonstrated awareness may be identified, for example, using standard or proprietary data analysis tools, including without limitation big data analysis tools such as text analytics, topic modeling, keyword matching against an ideal profile for a candidate subject S or sentiment analysis.

According to step 106b, the candidate subjects S are identified as those among the subjects S located in the geographic region GR that are found, as the result of the filtering in step 106a, to be associated with one or more topics relating to the brand that will ultimately market to the subjects S located in the geographic region GR according to the process 100.

As shown in FIG. 2, the system 200 is configured to store the results of step 106 as filtered social media data 204 representing, as data, the candidate subjects S, as well as social media connectivity and social media content for the candidate subjects S.

In general, the effectiveness of eventual marketing to the candidate subjects S over the internet using a social media platform may be a product, among other things, of the spread and positive reception of the marketing among the candidate subjects S. According to the process 100, in order to increase the eventual marketing's effectiveness, beyond identifying the candidate subjects S represented in the filtered social media data 204, as described above, in steps 108 and 110 described below, like candidate subjects S are selected from among the candidate subjects S and grouped into one or more clusters of target subjects S for marketing.

To support the selection of clusters of target subjects S from among the candidate subjects S, in step 108, the candidate subjects S are tagged, in data, with additional information. The additional information about the candidate subjects S may be any information having significance in the context of selecting like candidate subjects S to group into a cluster of target subjects S for marketing in a manner that promotes the spread and positive reception of the marketing among the cluster's target subjects S.

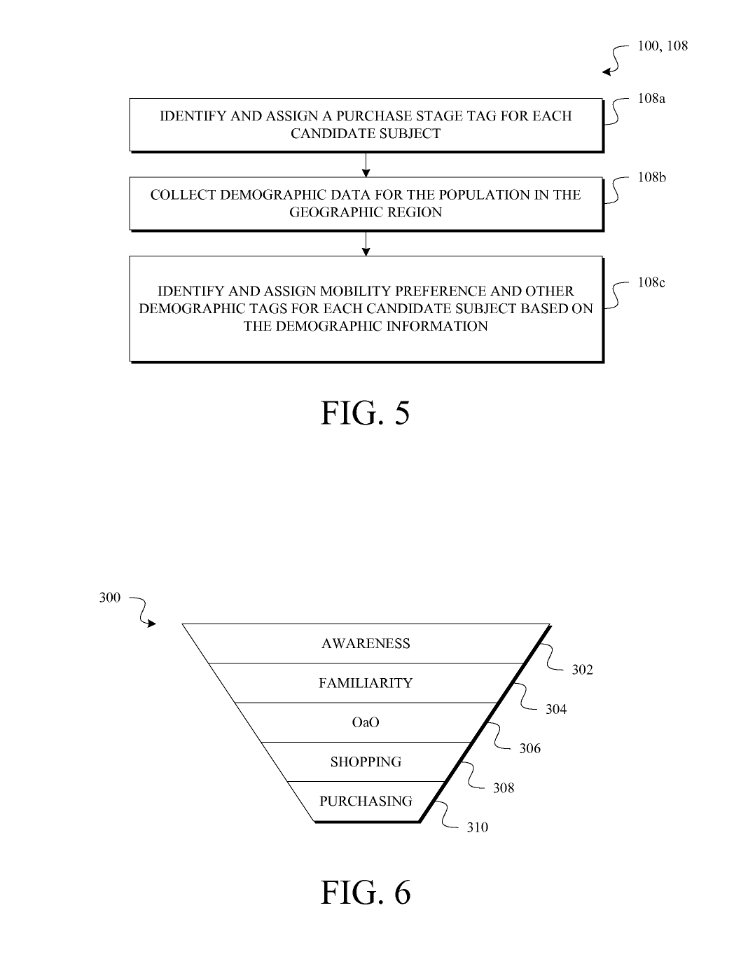

For instance, as shown with additional reference to FIG. 5, in step 108a, purchase stage tags for the candidate subjects S are identified and assigned, in data, to the candidate subjects S. The purchase stage tags represent, for the candidate subjects S, their purchase stage with respect to the brand that will ultimately market to the candidate subjects S according to the process 100. More specifically, the purchase stage for a candidate subject S generally indicates their proximity to purchasing from the brand.

Non-limiting examples of purchase stages for the candidate subjects S are represented in the purchase funnel 300 shown in FIG. 6. As generally shown, the purchase funnel 300 may include a plurality of purchase stages. In the example, the purchase stages are progressive, meaning that each successive purchase stage indicates closer proximity to a purchase from the brand. According to the examples, the purchase stages of the purchase funnel 300 may include, for instance, an awareness purchase stage 302 indicating, for a candidate subject S, that the candidate subject S has a general awareness of the brand or of one of the brand's products or services, a familiarity purchase stage 304 indicating, for a candidate subject S, that the candidate subject S is familiar with the brand or of one of the brand's products or services, an overall opinion, or OaO, purchase stage 306 indicating, for a candidate subject S, that the candidate subject S has an opinion of the brand or of one of the brand's products or services, a shopping purchase stage 308 indicating, for a candidate subject S, that the candidate subject S is shopping for one of the brand's products or services, and a purchasing purchase stage 310 indicating, for a candidate subject S, that the candidate subject S is purchasing one of the brand's products or services.

The purchase stage tags for the candidate subjects S may be reflected in any of the available information about the candidate subjects S represented the filtered social media data 204, such as, for example, their social media connectivity and/or their social media content. The purchase stage tags may be identified, for example, using standard or proprietary data analysis tools, including without limitation big data analysis tools such as text analytics, topic modeling or sentiment analysis.

In addition to identifying additional information about the candidate subjects S from the filtered social media data 204 derived from a social media platform, the additional information about the candidate subjects S can be identified from data derived from outside social media platforms.

For instance, in step 108b, population information is collected and stored as demographic data 206, as shown with additional reference to FIG. 2. The demographic data 206 may be derived from local, state or national governments, from public or private business entities, or from individual collection efforts, for instance, or from any combination of these. The demographic data 206 represents, as data, attributes of the population in the geographic region GR in which the candidate subject S are located. According to the example demographic data 206 in FIG. 2, and in furtherance to the example above where the brand that will ultimately market to the candidate subjects S in the geographic region GR according to the process 100 is an automotive brand, these attributes may include, for instance, the population's mobility preferences. As shown in FIG. 2, these attributes may alternatively or additionally include, for instance, the population's ages, ethnicities and incomes.

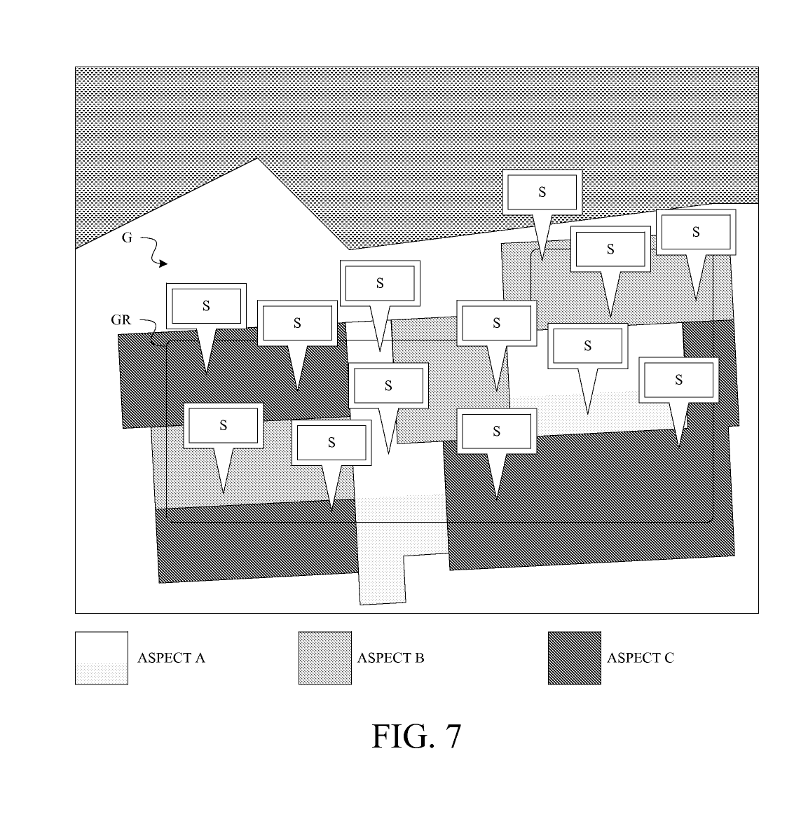

As shown with additional reference to FIG. 7, the demographic data 206 may represent, for the attributes of the population in the geographic region GR, as data, information about geographic boundaries in which certain aspects of those attributes exist or predominate. Depending on the attribute, the aspects may be values, ranges, ratios, percentages or any other measures. For example, for the population's mobility preference, the demographic data 206 may represent one or more geographic boundaries in which the population's mobility preference includes or is predominantly ride sharing, one or more geographic boundaries in which the population's mobility preference includes or is predominantly heavy driving, one or more geographic boundaries in which the population's mobility preference includes or is predominantly frequent air travel, etc. As another example, for the population's mobility age, the demographic data 206 may represent one or more geographic boundaries in which the population's age includes or is predominantly in a 20-30 years old age range, one or more geographic boundaries in which the population's age includes or is predominantly in a 30-40 years old age range, one or more geographic boundaries in which the population's age includes or is predominantly in a 40-50 years old age range, etc.

In step 108c, demographic tags for the candidate subjects S are identified and assigned, in data, to the candidate subjects S. The demographics tags represent, for the candidate subjects S, one or more attributes of their population represented in the demographic data 206. As reflected in FIG. 7, based on the identified locations of the candidate subjects S, the information represented in the demographic data 206 can be overlaid with the filtered social media data 204 representing the candidate subjects S. For instance, a candidate subjects S located in a geographic boundary in which the population's mobility preference includes or is predominately heavy driving can be tagged, in data, with a corresponding heavy driving mobility preference tag (e.g., 20% heavy drivers, 60% heavy drivers, predominately heavy drivers, etc.). And, for instance, a candidate subjects S located in a geographic boundary in which the population's age includes or is predominately in a 20-30 years old age range can be tagged, in data, with a corresponding20-30 years old age tag (e.g., 20% 20-30 years old age range, 60% 20-30 years old age range, predominately 20-30 years old age range, etc.). In this way, the filtered social media data 204 derived from a social media platform is supplemented with the demographic data 206 derived from outside social media platforms.

As shown in FIG. 2, the system 200 is configured to store the results of step 108 as supplemented social media data 208 representing, as data, the candidate subjects S, as well as, for the candidate subjects S, their social media connectivity, purchase stage tags representing their proximity to purchasing from the brand that will ultimately market to the candidate subjects S according to the process 100 and demographics tags representing one or more attributes of their population.

It can be seen that, with the process 100 and the system 200, the candidate subjects S are tagged, in data, with additional information. The additional information may, like the purchase stage tags, represent additional information particular to the candidate subjects S. The additional information may also, like the demographic tags, represent additional information about the candidate subjects S generalized from information about their population. Together, these pieces of additional information support efforts to understand more about the candidate subjects S for purposes of promoting the effectiveness of eventual marketing to the candidate subjects S over the internet using a social media platform.

In step 110 of the process 100, the candidate subjects S are clustered into clusters of like target subjects S based on their tagging. In particular, based on their tagging, like candidate subjects S are selected from among the candidate subjects S and grouped, in data, into one or more clusters of target subjects S for marketing.

One, some or all of the above described purchase stage tags and demographic tags may be identified and assigned, in data, to the candidate subjects S and used in this selection, either alone or in combination with other tags assigned in data to the candidate subject S. In one non-limiting example in furtherance to the example above where the brand that will ultimately market to the candidate subjects S according to the process 100 is an automotive brand, at least mobility preference tags are identified and assigned, in data, to the candidate subjects S, and used in this selection. According to these examples, a cluster, for instance, could include the candidate subjects S represented by their purchase stage tags and demographic tags to have an opinion of the brand or of one of the brand's products or services, to be engaged or have a likelihood of being engaged in heavy driving and to be 20-30 years in age Likewise according to these examples, a cluster, for instance, could include the candidate subjects S represented by their purchase stage tags and demographic tags to have an opinion of the brand or of one of the brand's products or services, to be engaged or have a likelihood of being engaged in heavy driving, to be or have a likelihood of being 20-30 years in age, to have or have a likelihood of having a particular ethnicity and to have or have a likelihood of having a particular income.

As shown in FIG. 8, the process 100 proceeds to market to the target subjects S over the internet using a social media platform.

It will be understood that the process 100 in connection with step 110 may proceed to market to the target subjects S in one, some or all of the clusters of target subjects S for marketing. In some examples, for instance, the clusters of target subjects S for marketing could be rank ordered by number of target subjects S, and the process 100 may proceed in whole or in part to market to the target subjects S in clusters having a certain number of target subjects S.

In other examples, for instance, the process 100 in connection with step 110 may proceed in whole or in part to market to the target subjects S whose clusters form or include one or more identified social media communities.

In these examples, for a cluster of target subjects S, a social media community can be identified with reference to the connections among the target subject S over a social media platform, other connections over a social media platform directly or indirectly involving the target subject S, or both. For instance, the process 100 can determine intra-cluster density, or the degree to which the target subjects S in a cluster are connected to one another, and inter-cluster density, or the degree to which the target subjects S in a cluster are connected to subjects S outside the cluster. It is contemplated, for example, that inter-cluster density could be expressed as a ratio of the connections between the target subjects S in the cluster to the amount of possible connections between the target subjects S in the cluster, while inter-cluster density could be expressed as a ratio the amount of connections between the target subjects S in the cluster and subjects S outside the cluster to the amount of possible connections between the target subjects S in the cluster and subjects S outside the cluster.

Higher intra-cluster densities could be indicative of a social media community in the cluster of target subjects S, either alone or in combination with lower inter-cluster densities, for instance. According to this example, a social media community can be identified in the cluster of target subjects S if the determined intra-cluster density is above a desired threshold for intra-cluster density and the inter-cluster density is below a desired threshold for inter-cluster density. Among identified social media communities, their strengths may also be identified as a product of their intra-cluster densities, and optionally, their inter-cluster densities.

The process 100 in connection with step 110 may optionally cluster the candidate subjects S into clusters, based on their tagging, in a manner that promotes the formation or inclusion of one or more social media communities.

In one example, based on a subset of their tagging, like candidate subjects S may be selected from among the candidate subjects S and grouped, in data, into a preliminary cluster of target subjects S for marketing. If a social media community cannot be identified in the preliminary cluster of target subjects S, one, some of all of their remaining tagging may be used to further iteratively partition the preliminary cluster of target subjects S until a social media community is identified. Similarly, in another example, based on some or all of their tagging, like candidate subjects S may be selected from among the candidate subjects S and grouped, in data, into a preliminary cluster of target subjects S for marketing. If a social media community cannot be identified in the preliminary cluster of target subjects S, one, some of their tagging may be removed to iteratively un-partition the preliminary cluster of target subjects S until a social media community is identified.

In these examples, if a social media community is identified in a preliminary cluster of target subjects S selected based on their tagging, their remaining tagging may be used to further iteratively partition the preliminary cluster of target subjects S, and /or their tagging may be removed to iteratively un-partition the preliminary cluster of target subjects S in order to increase the strength of the identified social media community.

It will be understood that at any point, the process 100 in connection with step 110 may also combine clusters of target subjects S for marketing. Clusters of target subjects S for marketing with high inter-cluster density to one another may be combined, for instance. Alternatively, or additionally, clusters of target subjects S for marketing with high strength social media communities may be combined, for instance.

According to step 112 of the process 100, for each cluster of target subjects S, one or more representative target subjects S are identified from among their cluster.

The representative target subjects S may, for example, be those among a cluster of target subjects S demonstrating some degree of effectiveness in spreading social media content among other subjects S in a social media platform, in supporting the positive reception of social media content among other subjects S in a social media platform, or both. A representative target subject S, for instance, may demonstrate a degree of effectiveness in spreading social media content among other subjects S by, for example, being connected in a social media platform with large numbers of other subjects S. Such a representative target subject S, in other words, is well connected in a social media platform. Alternatively, or additionally, a representative target subject S, for instance, may demonstrate a degree of effectiveness in supporting the positive reception of social media content among other subjects S by, for example, having their social media content be shared in a social media platform by large numbers of other subjects S. Such a representative target subject S, in other words, is well regarded, or trustworthy, in a social media platform.

These and other aspects of the representative target subject S may be reflected in any of the available information about the target subjects S represented the supplemented social media data 208, such as, for example, their social media connectivity, and may be identified, for example, using standard or proprietary social media data analysis tools, including without limitation graph analytics or influence analysis.

The representative target subjects S for a given cluster of target subjects S may be identified in whole or in part using the above described purchase stage tags or demographic tags assigned to the target subjects S in the cluster. Using the purchase stage tags as an example, if, for instance, the target subjects S in the cluster are represented by their purchase stage tags to already have an opinion of the brand that will ultimately market to the target subjects S according to the process 100, or of one of the brand's products or services, one or more of the more well connected subjects S may be identified as the representative target subjects S. On the other hand, for instance, if the target subjects S in the cluster are represented by their purchase stage tags to only have a general awareness of the brand or of one of the brand's products or services, one or more of the more well regarded, or trustworthy, subjects S may be identified as the representative target subjects S.

In step 114 of the process 100, for each cluster of target subjects S, a marketing message is sent, over the internet using a social media platform, to the target subjects S in the cluster by or on the behalf of a brand. The marketing message can, for instance, relate to the brand. Once again in furtherance to the example above where the brand is an automotive brand, the marketing message may relate, for instance, to automobiles generally, to the automotive brand itself generally, to one of the automotive brand's product lines, or to one or more of the automotive brand's specific products or services.

As shown with additional reference to FIG. 2, the system 200 stores marketing data 210 representing, as data, a plurality of marketing messages. The marketing messages may, for example, be generally aimed at moving target subjects S in a cluster progressively down the purchase funnel 300 shown in FIG. 6, closer in proximity to a purchase from the brand, towards the purchasing purchase stage 310.

According to the illustrated example, the marketing messages may each be tailored to one or more clusters of target subjects S, for example, based in whole or in part on the above described purchase stage tags or demographic tags assigned to the target subjects S in the cluster.

Taking the purchase stage tags as a non-limiting example, for clusters in which the target subjects S are represented by their purchase stage tags to have a general awareness of the brand or of one of the brand's products or services or a familiarity with the brand or of one of the brand's products or services, the marketing message could be a general marketing message relating to the brand of the type commonly associated with fixed marketing investment and aimed to foster general awareness of the brand or of one of the brand's products or services, familiarity with the brand or of one of the brand's products or services or an opinion of the brand or of one of the brand's products or services, for instance. However, for clusters in which the target subjects S are represented by their purchase stage tags to have an opinion of the brand or of one of the brand's products or services or to be shopping for one of the brand's products or services, the marketing message could be a targeted marketing message relating to the brand of the type commonly associated with variable marketing investment, such as an offer, a discount or other promotion aimed to foster shopping for one of the brand's products or services or a purchase one of the brand's products or services, for instance.

As generally described above, in the illustrated example of the process 100 and system 200, a marketing message from among the plurality of marketing messages represented in the marketing data 210 and tailored to a cluster of target subjects S is sent, over the internet using a social media platform, to at least the one or more representative target subjects S. In this example, among other things, the likeness among the target subjects S in the cluster, the tailoring of the marketing messages to the clusters and the identification of the representative target subjects S, can, for example, support the spread and positive reception of the marketing message among the target subjects S in the cluster.

With the spread and positive reception of the marketing message among the target subjects S in a cluster, the expectation for the marketing message is that the target subjects S will move progressively down the purchase funnel 300 shown in FIG. 6, closer in proximity to a purchase from the brand, towards the purchasing purchase stage 310.

According to the process 100, in step 116, at least some of the candidate subjects S in the geographic region GR are re-tagged, in data, with updated additional information according to step 108, and in step 118, changes between the prior tags and the updated tags for the candidate subjects S are identified and used to evaluate the effectiveness of the marketing message.

In the illustrated example for instance, in step 116, at least some of the target subjects S are re-tagged, in data, with updated additional information according to step 108, including at least with updated purchase stage tags. In some implementations of the process 100, the target subjects S may, for example, be the previously identified target subjects S. In these implementations, the target subjects S may be re-tagged, in data, with updated additional information according to step 108, including at least with updated purchase stage tags, and in step 118, the progression of the target subjects S closer in proximity to a purchase from the brand, as reflected by changes between the prior purchase stage tags and the updated purchase stage tags for the same identified target subjects S, is identified and used to evaluate the effectiveness of the marketing message. In other implementations of the process 100, target subjects S may, for example, be re-identified among the same or newly identified candidate subjects S located in the geographic region GR according to step 106. In these implementations, target subjects S may be re-tagged, in data, with updated additional information according to step 108, including at least with updated purchase stage tags. In step 118, the progression of target subjects S closer in proximity to a purchase from the brand, as reflected by changes between the prior purchase stage tags and the updated purchase stage tags for otherwise like target subjects S, as reflected by the likeness in the remaining prior and updated tags, is identified and used to evaluate the effectiveness of the marketing message.

While recited characteristics and conditions of the invention have been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A computer-aided method for marketing to subjects in a social media platform over the internet, comprising:
supplementing social media data derived from a social media platform and representing candidate subjects for marketing with demographic data derived from outside social media platforms and representing attributes of a population by assigning, in data, the candidate subjects with demographic tags that indicate an attribute of their population;
selecting, from the data, a cluster of target subjects for marketing from among the candidate subjects based on the demographic tags; and
sending, over the internet using a social media platform, a marketing message to at least one of the target subjects in the cluster.

2. The computer-aided method of claim 1, wherein the social media data further represents social media content for the candidate subjects, further comprising:
assigning, in the data, the candidate subjects with purchase stage tags identified from their social media content that indicate their proximity to purchasing from a brand to which the marketing message relates, wherein the selecting is further based on the purchase stage tags.

3. The computer-aided method of claim 1, wherein the social media data further represents social media connectivity for the candidate subjects, further comprising:
selecting a representative target subject in the cluster based on their social media connectivity, wherein the sending is to the representative target subject.

4. The computer-aided method of claim 3, further comprising:
selecting the marketing message form a plurality of marketing messages based on the demographic tags.

5. The computer-aided method of claim 1, further comprising:
prior to the sending, assigning, in the data, the target subjects with purchase stage tags that indicate their proximity to purchasing from a brand to which the marketing message relates; and
after allowing the marketing message to spread among the target subjects in the cluster over the social media platform, reassigning, in the data, at least some of the target subjects with updated purchase stage tags.

6. The computer-aided method of claim 5, further comprising:
identifying changes between the purchase stage tags and the updated purchase stage tags; and
based on the changes, determining the effectiveness of the marketing message.

7. The computer-aided method of claim 1, wherein the marketing message relates to automobiles, and the indicated attribute relates to the population's mobility preference.

8. The computer-aided method of claim 1, wherein the indicated attribute relates to at least one of the population's age, ethnicity or income.

9. A computing device for marketing to subjects in a social media platform over the internet, comprising:
a memory including a non-transitory computer readable medium; and
a processor configured to execute instructions stored on the non-transitory computer readable medium to:
supplement social media data derived from a social media platform and representing candidate subjects for marketing with demographic data derived from outside social media platforms and representing attributes of a population by assigning, in data, the candidate subjects with demographic tags that indicate an attribute of their population;
select, from the data, a cluster of target subjects for marketing from among the candidate subjects based on the demographic tags; and
send, over the internet using a social media platform, a marketing message to at least one of the target subjects in the cluster.

10. The computing device of claim 9, wherein the social media data further represents social media content for the candidate subjects, and the processor is configured to execute instructions stored on the non-transitory computer readable medium to:
assign, in the data, the candidate subjects with purchase stage tags identified from their social media content that indicate their proximity to purchasing from a brand to which the marketing message relates, wherein the selecting is further based on the purchase stage tags.

11. The computing device of claim 9, wherein the social media data further represents social media connectivity for the candidate subjects, and the processor is configured to execute instructions stored on the non-transitory computer readable medium to:
select a representative target subject in the cluster based on their social media connectivity, wherein the sending is to the representative target subject.

12. The computing device of claim 11, wherein the processor is configured to execute instructions stored on the non-transitory computer readable medium to:
select the marketing message form a plurality of marketing messages based on the demographic tags.

13. The computing device of claim 9, wherein the processor is configured to execute instructions stored on the non-transitory computer readable medium to:
prior to the sending, assign, in the data, the target subjects with purchase stage tags that indicate their proximity to purchasing from a brand to which the marketing message relates; and
after allowing the marketing message to spread among the target subjects in the cluster over the social media platform, reassign, in the data, at least some of the target subjects with updated purchase stage tags.

14. The computing device of claim 13, wherein the processor is configured to execute instructions stored on the non-transitory computer readable medium to:
identify changes between the purchase stage tags and the updated purchase stage tags; and
based on the changes, determine the effectiveness of the marketing message.

15. The computing device of claim 9, wherein the marketing message relates to automobiles, and the indicated attribute relates to the population's mobility preference.

16. The computing device of claim 9, wherein the indicated attribute relates to at least one of the population's age, ethnicity or income.

17. A computer-aided method for marketing to subjects in a social media platform over the internet, comprising:
defining a geographic region;
collecting social media data derived from a social media platform and representing candidate subjects for marketing located in the geographic region;
collecting demographic data derived from outside social media platforms and representing attributes of a population in the geographic region;
based on the demographic data, identifying, for each of the candidate subjects, a plurality of attributes of their population, the attributes including an attribute relating to the population's mobility preference;
assigning, in data, each of the candidate subjects with demographic tags that indicate the identified attributes of their population;
selecting, from the data, a cluster of target subjects for marketing from among the candidate subjects based on similarities in the demographic tags for the target subjects; and
sending, over the internet using a social media platform, an automotive brand's marketing message to at least one of the target subjects in the cluster.

18. The computer-aided method of claim 17, wherein the social media data further represents social media content for the candidate subjects, further comprising:
based on the social media content, identifying, for each of the candidate subjects, their proximity to purchasing an automobile from the automotive brand; and
assigning, in the data, each of the candidate subjects with purchase stage tags that indicate their identified proximity to purchasing an automobile from the automotive brand, wherein the selecting is further based on similarities in the purchase stage tags for the target subjects.

19. The computer-aided method of claim 18, further comprising:
after allowing the marketing message to spread among the target subjects in the cluster over the social media platform, based on updated social media content, re-identifying, for at least some of the target subjects, their proximity to purchasing an automobile from the automotive brand;
re-assigning, in the data, the at least some of the target subjects with updated purchase stage tags that indicate their re-identified proximity to purchasing an automobile from the automotive brand;
identifying the changes between the purchase stage tags and the updated purchase stage tags; and
based on the changes, determining the effectiveness of the marketing message.

20. The computer-aided method of claim 18, wherein, in addition to the attribute relating to the population's mobility preference, the attributes include at least one attribute relating to one of the population's age, ethnicity or income.
